(19) United States
(12) Patent Application Publication
(10) Pub. No.: US 2026/0126653 A1
(43) Pub. Date: May 7, 2026

(54) LIGHT GUIDE DEVICE AND NEAR-EYE DISPLAY

(71) Applicant: Coretronic Corporation, Hsin-Chu (TW)

(72) Inventors: Yi-Chien Lo, Hsin-Chu (TW); Wen-Chun Wang, Hsin-Chu (TW)

(73) Assignee: Coretronic Corporation, Hsin-Chu (TW)

(21) Appl. No.: 19/365,196

(22) Filed: Oct. 22, 2025

(30) Foreign Application Priority Data
Nov. 7, 2024 (CN) 202411578866.0

(51) Int. Cl. G02B 27/01; G02B 6/27; G02B 6/34

(52) U.S. Cl. CPC G02B 27/0172; G02B 6/2726; G02B 6/34

(57) ABSTRACT

A light guide device including a light guide plate, a diffraction grating and a phase retardation element is provided. The diffraction grating is disposed on a first surface of the light guide plate. The diffraction grating is used to provide a plurality of diffraction beams, while a light beam is incident to the diffraction grating. The diffraction beams include a major diffraction beam, and the major diffraction beam propagates in the light guide plate. The phase retardation element is disposed on a transmission path of the major diffraction beam. The major diffraction beam has a first polarization state before being incident to the phase retardation element. The major diffraction beam has a second polarization state when leaving the phase retardation element. The first polarization state is different from the second polarization state. A near-eye display having an image light source and the light guide device is also provided.

### CROSS-REFERENCE TO RELATED APPLICATION

This application claims the priority benefit of China application serial no. 202411578866.0 filed on Nov. 7, 2024. The entirety of the above-mentioned patent application is hereby incorporated by reference herein and made a part of this specification.

### BACKGROUND

### Technical Field

The invention relates to an optical device, and particularly relates to a light guide device and a near-eye display.

### Description of Related Art

Diffractive waveguides may be thinner in thickness than geometric waveguides. Currently, diffractive waveguides include surface relief grating (SRG), volume holographic grating (VHG) and polarization volume grating (PVG). The surface relief grating (SRG) has advantages over other diffractive gratings in terms of efficiency and design freedom.

In an ideal state, it is expected that a diffraction beam generated by a coupling-in grating may be completely transmitted to a waveguide outlet in a total reflection manner within the waveguide. However, the coupling-in grating usually has a certain area, so that the diffraction beam generated through the coupling-in grating re-enters the coupling-in grating after total reflection of the diffraction beam within the waveguide, resulting in further diffraction and undesired light leakage.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a light guide device with low energy consumption and good optical performance.

Additional aspects and advantages of the present invention will be set forth in the description of the techniques disclosed in the present invention.

In order to achieve one or a portion of or all of the objects or other objects, an embodiment of the invention provides a light guide device adapted to guide a light beam, and including a light guide plate, a diffraction grating and a phase retardation element. The diffraction grating is disposed on a first surface of the light guide plate, where when the light beam is incident on the diffraction grating, the diffraction grating is adapted to generate a plurality of diffraction beams, and the diffraction beams include a major diffraction beam, and the major diffraction beam is transmitted in the light guide plate. The phase retardation element is disposed on a transmission path of the major diffraction beam. The major diffraction beam has a first polarization state before being incident on the phase retardation element, and the major diffraction beam has a second polarization state when leaving the phase retardation element, where the first polarization state is different from the second polarization state.

Another embodiment of the invention provides a near-eye display including an image light source and a light guide device. The image light source is adapted to emit a light beam. The light guide device is disposed on a transmission path of the light beam and is adapted to guide the light beam, and includes a light guide plate, a diffraction grating and a phase retardation element. The diffraction grating is disposed on a first surface of the light guide plate, where when the light beam is incident on the diffraction grating, the diffraction grating is adapted to generate a plurality of diffraction beams, and the diffraction beams include a major diffraction beam, and the major diffraction beam is transmitted in the light guide plate. The phase retardation element is disposed on a transmission path of the major diffraction beam. The major diffraction beam has a first polarization state before being incident on the phase retardation element, and the major diffraction beam has a second polarization state when leaving the phase retardation element, where the first polarization state is different from the second polarization state.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 8 are respectively schematic diagram of light guide devices according to a first to an eighth embodiments of the invention.

FIG. 9 is a schematic diagram of a near-eye display according to the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

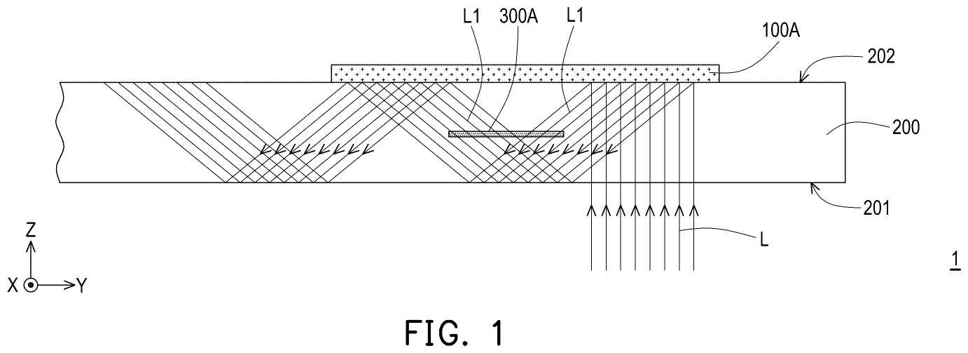

Referring to FIG. 1, FIG. 1 is a schematic diagram of a light guide device according to a first embodiment of the invention. The light guide device 1 includes a light guide plate 200, a diffraction grating 100A, and a phase retardation element 300A. The light guide plate has two surfaces 201 and 202 opposite to each other.

The diffraction grating 100A may be, for example, a surface relief grating (SRG), but the invention is not limited thereto. The diffraction grating 100A serving as a coupling-in grating is disposed on the surface 202 of the light guide plate 200. In the embodiment, the diffraction grating 100A is formed by coating a material on the surface 202 of the light guide plate 200 and then imprinting the same. However, the invention is not limited thereto. In other embodiments, the diffraction grating 100A may also be formed by directly etching the surface 202 of the light guide plate 200. In the embodiment, the diffraction grating 100A is, for example, a blazed grating, a binary grating and a slanted grating, and is preferably a blazed grating. The light guide device 1 is suitable for guiding the light beam L. Specifically, a light beam L enters the light guide plate 200 through the surface 201 of the light guide plate 200 along an incident direction (+Z direction). The diffraction grating 100A is disposed on a transmission path of the light beam L. When the light beam L is incident on the diffraction grating 100A, a plurality of diffraction beams, including 0^{th}-order diffraction light, ±1^{st}-order diffraction light, ±2^{nd}-order diffraction light . . . ±n^{th}-order diffraction light, ±(n+1)^{th}-order diffraction light . . . , etc., are generated, wherein the 0^{th}-order diffraction light is directly reflected along a direction parallel to the incident direction (−Z direction). In the embodiment, a major diffraction beam L1 transmitted in the light guide plate 200 is the ±1^{st}-order diffraction light (or −1^{st}-order diffraction light) adjacent to the 0^{th}-order diffraction light. When the diffraction efficiency is relatively poor, a light intensity of the ±1^{st}-order diffraction light is slightly less than the 0^{th}-order diffraction light; and when the diffraction efficiency is good, the light intensity of the ±1^{st}-order diffraction light may be even greater than that of the 0^{th}-order diffraction light. A light emission direction of the major diffraction beam L1 may be controlled by a structure shape of the diffraction grating 100A. As shown in FIG. 1, the diffraction grating 100A is a reflective diffraction grating, and the major diffraction beam L1 may exit the diffraction grating 100A at an angle relative to the incident direction, and therefore may be transmitted within the light guide plate 200.

It should be noted that since the structure of the diffraction grating 100A is directional, it is easy to produce polarization selectivity, in which the s-waves (or the p-waves) have better diffraction efficiency. Therefore, in the embodiment, the light beam L incident on the light guide device 1 has a polarization state. The light beam L may be an s-wave or a p-wave according to design requirements, but the invention is not limited thereto, and the light beam L may also be non-polarized light without a specific polarization state. Furthermore, the structure of the diffraction grating 100A is repetitive. Therefore, when an area size of the diffraction grating 100A is much larger than a beam size of the major diffraction beam L1, the major diffraction beam L1 may be totally reflected in the light guide plate 200 as shown in FIG. 1 and then incident on the diffraction grating 100A, and if the polarization state of the major diffraction beam L1 remains unchanged, diffraction occurs, resulting in energy loss.

In order to solve the aforementioned energy loss issue, the light guide device 1 provided in the embodiment has a phase retardation element 300A disposed on a transmission path of the major diffraction beam L1 to change the polarization state of the major diffraction beam L1 before the major diffraction beam L1 enters the diffraction grating 100A, so that the polarization state of the major diffraction beam L1 when leaving the phase retardation element 300A is different from its polarization state before entering the phase retardation element 300A. Accordingly, even if the major diffraction beam L1 is inevitably incident on the diffraction grating 100A due to the large area of the diffraction grating 100A, a degree of diffraction of the major diffraction beam L1 may be reduced or the diffraction phenomenon of the major diffraction beam L1 may be avoided.

In some embodiments provided by the invention, as shown in FIG. 1, the phase retardation element 300A is located in the light guide plate 200 and is parallel to the surface 201 and the surface 202 of the light guide plate 200, but the invention is not limited thereto. The major diffraction beam L1 only passes through the phase retardation element 300A once before entering the diffraction grating 100A, and its polarization state is changed to reduce the degree of diffraction occurring after the major diffraction beam L1 enters the diffraction grating 100A.

In some embodiments, the light beam L incident on the diffraction grating 100A is an s-wave, so that the major diffraction beam L1 generated by diffracting the light beam L via the diffraction grating 100A is also an s-wave, and the phase retardation element 300A is a half-wave plate. The phase retardation element 300A is located in the light guide plate 200 and is parallel to the surface 201 and the surface 202 of the light guide plate 200. Since the major diffraction beam L1 may is emitted out of the diffraction grating 100A at an angle relative to the incident direction, the major diffraction beam L1 is obliquely incident on the phase retardation element 300A. As shown in FIG. 1, by adjusting a position of the phase retardation element 300A on the transmission path of the major diffraction beam L1, the major diffraction beam L1 only passes through the phase retardation element 300A once. Accordingly, the major diffraction beam L1 is a p-wave when leaving the phase retardation element 300A, which avoids the diffraction phenomenon of the major diffraction beam L1 occurring after the major diffraction beam L1 is incident on the diffraction grating 100A. However, it should be understood that since the major diffraction beam L1 is not a collimated beam, the part of the major diffraction beam L1 that passes through the phase retardation element 300A again due to reflection and other factors is ignored here.

In other embodiments, the light beam L incident on the diffraction grating 100A is a p-wave, so that the major diffraction beam L1 generated by diffracting the light beam L via the diffraction grating 100A is a p-wave, the phase retardation element 300A is a half-wave plate, and the major diffraction beam L1 only passes through the phase retardation element 300A once. Accordingly, the major diffraction light beam L1 is an s-wave when leaving the phase retardation element 300A, which avoids the diffraction phenomenon of the major diffraction beam L1 occurring after the major diffraction beam L1 is incident on the diffraction grating 100A.

In other embodiments, the light beam L incident on the diffraction grating 100A is non-polarized light, so that a part of the major diffraction beam L1 generated by diffracting the light beam L via the diffraction grating 100A is an s-wave, and a part of the major diffraction beam L1 is a p-wave, the phase retardation element 300A is a half-wave plate, and the major diffraction beam L1 only passes through the phase retardation element 300A once. Accordingly, when a part of the major diffraction beam L1 is an s-wave, the major diffraction beam L1 is a p-wave when leaving the phase retardation element 300A, which avoids the diffraction phenomenon of the major diffraction beam L1 occurring after the major diffraction beam L1 is incident on the diffraction grating 100A. When a part of the major diffraction beam L1 is a p-wave, the major diffraction beam L1 becomes an s-wave when leaving the phase retardation element 300A, thus avoiding the diffraction phenomenon of the major diffraction beam L1 occurring after the major diffraction beam L1 is incident on the diffraction grating 100A.

In order to fully illustrate various implementations of the invention, other embodiments of the invention will be described below. It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

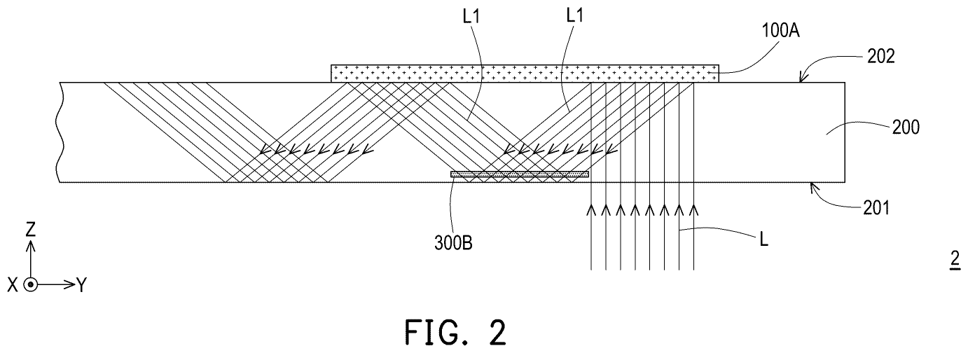

Referring to FIG. 2, FIG. 2 is a schematic diagram of a light guide device according to a second embodiment of the invention. A light guide device 2 includes a light guide plate 200, a diffraction grating 100A, and a phase retardation element 300B.

The light beam L enters the light guide plate 200 through the surface 201 of the light guide plate 200 along an incident direction (+Z direction). The diffraction grating 100A serving as the coupling-in grating is disposed on the surface 202 of the light guide plate 200 and is a reflective diffraction grating. In the embodiment, the major diffraction beam L1 transmitted in the light guide plate 200 is the ±1^{st}-order diffraction light (or −1^{st}-order diffraction light) adjacent to the 0^{th}-order diffraction light.

As shown in FIG. 2, the phase retardation element 300B is located in the light guide plate 200 and is parallel to the surface 201 and the surface 202 of the light guide plate 200, but the invention is not limited thereto. In the embodiment, by adjusting the position of the phase retardation element 300B on the transmission path of the major diffraction beam L1, the major diffraction beam L1 respectively passes through the phase retardation element 300B once before and after being totally reflected by the surface 201 of the light guide plate 200, so that the major diffraction beam L1 only passes through the phase retardation element 300B twice, and its polarization state is changed, which reduces the degree of diffraction occurring after the major diffraction beam L1 enters the diffraction grating 100A.

In some embodiments, the light beam L incident on the diffraction grating 100A is an s-wave, so that the major diffraction beam L1 generated by diffracting the light beam L via the diffraction grating 100A is an s-wave, and the phase retardation element 300B is a quarter-wave plate, by adjusting a position of the phase retardation element 300B on the transmission path of the major diffraction beam L1, the major diffraction beam L1 may only pass through the phase retardation element 300B twice. Accordingly, the major diffraction beam L1 is a p-wave when leaving the phase retardation element 300B, which avoids the diffraction phenomenon of the major diffraction beam L1 occurring after the major diffraction beam L1 is incident on the diffraction grating 100A. However, it should be noted that since the major diffraction beam L1 is not a collimated beam, the part of the major diffraction beam L1 that passes through the phase retardation element 300B again due to reflection and other factors is ignored here.

In other embodiments, the light beam L incident on the diffraction grating 100A is a p-wave, so that the major diffraction beam L1 generated by diffracting the light beam L via the diffraction grating 100A is a p-wave, the phase retardation element 300B is a quarter-wave plate, and the major diffraction beam L1 only passes through the phase retardation element 300B twice. Accordingly, the major diffraction light beam L1 is an s-wave when leaving the phase retardation element 300B, which avoids the diffraction phenomenon of the major diffraction beam L1 occurring after the major diffraction beam L1 is incident on the diffraction grating 100A.

In other embodiments, the light beam L incident on the diffraction grating 100A is non-polarized light, so that a part of the major diffraction beam L1 generated by diffracting the light beam L via the diffraction grating 100A is an s-wave, and a part of the major diffraction beam L1 is a p-wave, the phase retardation element 300B is a quarter-wave plate, and the major diffraction beam L1 only passes through the phase retardation element 300B twice. Accordingly, when a part of the major diffraction beam L1 is an s-wave, the major diffraction beam L1 is a p-wave when leaving the phase retardation element 300B, which avoids the diffraction phenomenon of the major diffraction beam L1 occurring after the major diffraction beam L1 is incident on the diffraction grating 100A. When a part of the major diffraction beam L1 is a p-wave, the major diffraction beam L1 is an s-wave when leaving the phase retardation element 300B, thus avoiding the diffraction phenomenon of the major diffraction beam L1 occurring after the major diffraction beam L1 is incident on the diffraction grating 100A.

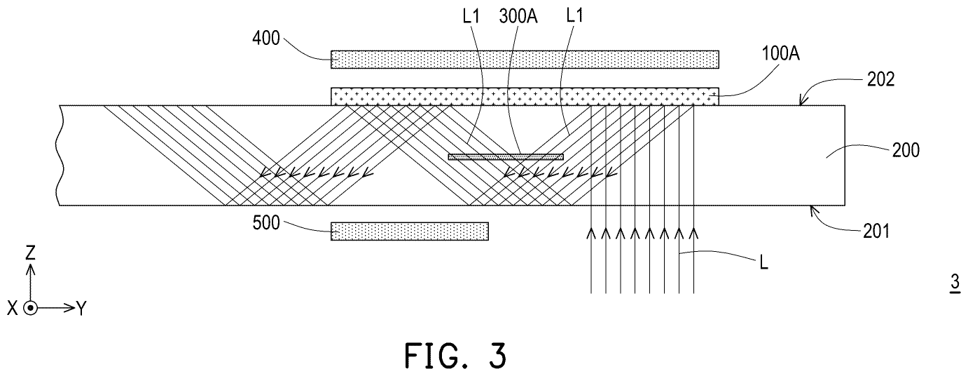

Referring to FIG. 3, FIG. 3 is a schematic diagram of a light guide device according to a third embodiment of the invention. A difference between a light guide device 3 of the embodiment and the light guide device 1 is that the light guide device 3 further includes a reflecting mirror 400 and a reflecting mirror 500. The reflecting mirror 400 is disposed on the surface 202 of the light guide plate 200, and the diffraction grating 100A is located between the reflecting mirror 400 and the light guide plate 200. The reflecting mirror 500 is disposed on the surface 201 of the light guide plate 200, and the light guide plate 200 is located between the reflecting mirror 400 and the reflecting mirror 500. In an embodiment, an orthogonal projection area of the diffraction grating 100A on the surface 202 of the light guide plate 200 is within an orthogonal projection area of the reflecting mirror 400 on the surface 202 of the light guide plate 200, so that the reflecting mirror 400 simultaneously covers the area where the light beam L is incident on the diffraction grating 100A and the area where the major diffraction beam L1 is incident on the diffraction grating 100A, but the invention is not limited thereto, and in other embodiments, multiple reflecting mirror may also be provided corresponding to the area where the light beam L is incident on the diffraction grating 100A and the area where the major diffraction beam L1 is incident on the diffraction grating 100A. In an embodiment, the reflecting mirror 500 is disposed corresponding to the area where the major diffraction beam L1 is incident on the diffraction grating 100A. Accordingly, the light that penetrates through the diffraction grating 100A and exits the light guide plate 200 may be reflected back into the light guide plate 200 by the reflecting mirror 400 and the reflecting mirror 500, thereby reducing energy consumption.

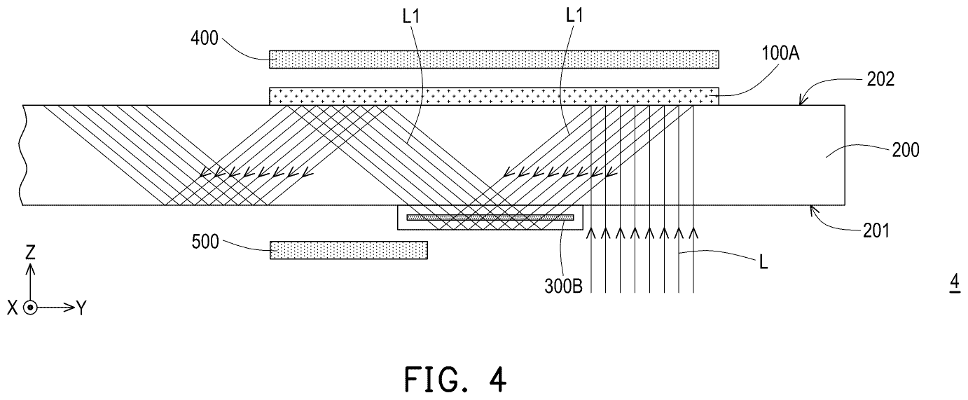

Referring to FIG. 4, FIG. 4 is a schematic diagram of a light guide device according to a fourth embodiment of the invention. A difference between a light guide device 4 of the embodiment and the light guide device 2 is that the light guide device 4 also includes a reflecting mirror 400 and a reflecting mirror 500, and the phase retardation element 300B is attached to the surface 201. The arrangement and functions of the reflecting mirror 400 and the reflecting mirror 500 are the same as those of the light guide device 3, and details thereof are not repeated. In the embodiment, since the phase retardation element 300B is located outside the light guide plate 200 and is attached to the surface 201, and the phase retardation element 300B further includes a protective layer (not indicated), the major diffraction beam L1 in the light guide plate 200 first passes through the surface 201 of the light guide plate 200 and then enters and passes through the phase retardation element 300B, and gets totally reflected at an interface between the protective layer of the phase retardation element 300B and the air, and then again passes through the phase retardation element 300B, and enters the light guide plate 200 through the surface 201 of the light guide plate 200 and is transmitted toward the diffraction grating 100A, so that the major diffraction beam L1 only passes through the phase retardation element 300B twice. The light that penetrates through the diffraction grating 100A and exits the light guide plate 200 is reflected back into the light guide plate 200 by the reflecting mirror 400 and the reflecting mirror 500, thereby reducing energy consumption.

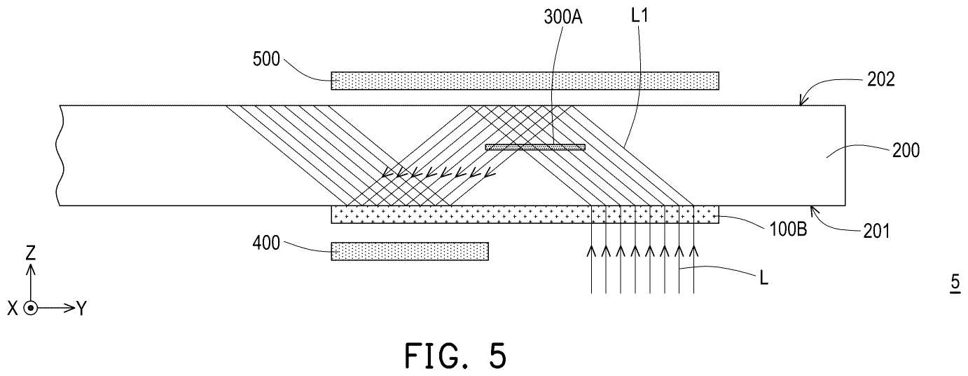

Referring to FIG. 5, FIG. 5 is a schematic diagram of a light guide device according to a fifth embodiment of the invention. A light guide device 5 includes the light guide plate 200, a diffraction grating 100B, the phase retardation element 300A, the reflecting mirror 400 and the reflecting mirror 500. The light that penetrates through the diffraction grating 100B and exits the light guide plate 200 is reflected back into the light guide plate 200 by the reflecting mirror 400 and the reflecting mirror 500, thereby reducing energy consumption.

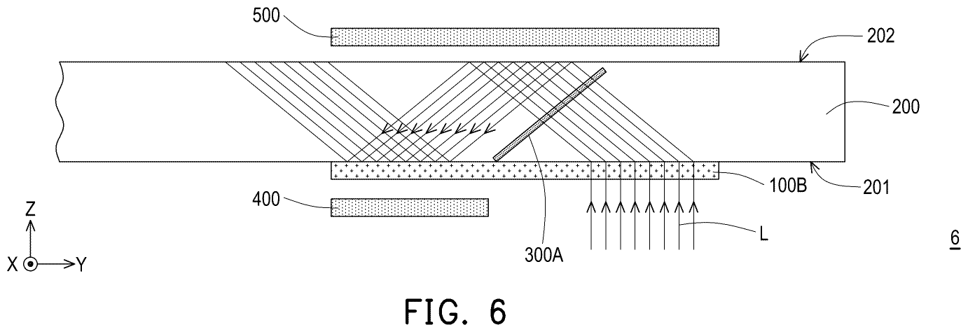

Referring to FIG. 1 and FIG. 3 at the same time, please refer to the previous descriptions for the same parts of the light guide device 5 and the light guide devices 1 and 3, which will not be repeated here. A difference between the light guide device 5 and the light guide device 3 is that the diffraction grating 100B serving as a coupling-in grating is disposed on the surface 201 of the light guide plate 200 and is a transmissive diffraction grating. In the embodiment, since the diffraction grating 100B is disposed on the surface 201 of the light guide plate 200, the reflecting mirror 400 is disposed on the surface 201 of the light guide plate 200, and the diffraction grating 100B is located between the reflecting mirror 400 and the light guide plate 200. The reflecting mirror 500 is disposed on the surface 202 of the light guide plate 200, and the light guide plate 200 is located between the reflecting mirror 400 and the reflecting mirror 500. Referring to FIG. 6, FIG. 6 is a schematic diagram of a light guide device according to a sixth embodiment of the invention. A difference between the light guide device 6 of the embodiment and the light guide device 5 is that the phase retardation element 300A is not parallel to the surface 201 and the surface 202 of the light guide plate 200.

In the embodiment, as shown in FIG. 6, the major diffraction beam L1 only passes through the phase retardation element 300A once, and its polarization state is changed, which reduces the degree of diffraction occurring after the major diffraction beam L1 is incident on the diffraction grating 100A. In some embodiments, the major diffraction beam L1 is an s-wave, the phase retardation element 300A is a half-wave plate, and the major diffraction beam L1 only passes through the phase retardation element 300A once. Accordingly, the major diffraction beam L1 is a p-wave when leaving the phase retardation element 300A, which avoids the diffraction phenomenon of the major diffraction beam L1 occurring after the major diffraction beam L1 is incident on the diffraction grating 100A. However, the is not limited thereto, in some embodiments, the major diffraction beam L1 is a p-wave and only passes through the phase retardation element 300A once. Accordingly, the major diffraction beam L1 is an s-wave when leaving the phase retardation element 300A, which avoids the diffraction phenomenon of the major diffraction beam L1 occurring after the major diffraction beam L1 is incident on the diffraction grating 100A.

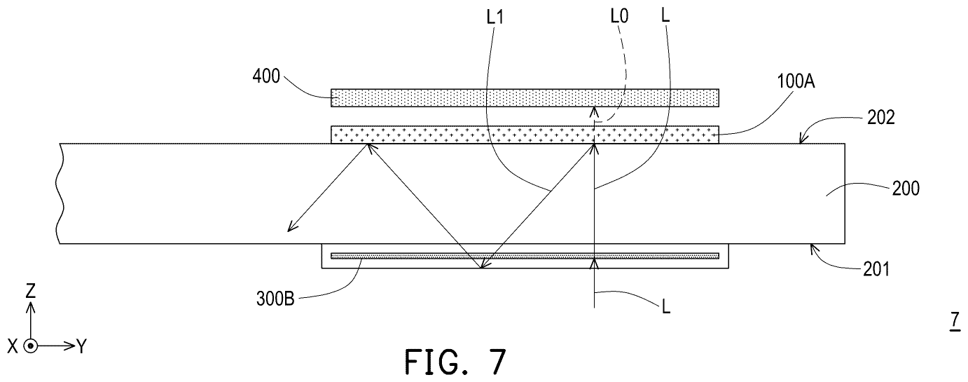

Referring to FIG. 7, FIG. 7 is a schematic diagram of a light guide device according to a seventh embodiment of the invention. A difference between a light guide device 7 of the embodiment and the light guide device 4 is that the light guide device 7 does not have the reflecting mirror 500, and the phase retardation element 300B is not only located on the transmission path of the major diffraction beam L1 before the major diffraction beam L1 is incident on the diffraction grating 100A, the phase retardation element 300B further extends to the transmission path of the light beam L before the light beam Lis incident on the light guide plate 200. In the embodiment, the reflecting mirror 400 is disposed on the surface 202 of the light guide plate 200, and the diffraction grating 100A is located between the reflecting mirror 400 and the light guide plate 200.

The diffraction grating 100A serving as a coupling-in grating is disposed on the surface 202 of the light guide plate 200, and is a reflective diffraction grating. The light beam L enters the light guide plate 200 through the surface 201 of the light guide plate 200 along an incident direction (+Z direction), and the light beam L passes through the phase retardation element 300B before entering the diffraction grating 100A. In the embodiment, the light beam L has a polarization state before entering the phase retardation element 300B, and changes its polarization state after penetrating through the phase retardation element 300B. The major diffraction beam L1 generated after the light beam L is incident on the diffraction grating 100A is ±1^{st}-order diffraction light (or −1^{st}-order diffraction light), and a secondary diffraction beam L0 is generated, where the secondary diffraction beam L0 is the 0^{th}-order diffraction light (penetrating through the diffraction grating 100A). As shown in FIG. 7, the major diffraction beam L1 exits the diffraction grating 100A at an angle relative to the incident direction, and therefore may be transmitted within the light guide plate 200. In addition, the secondary diffraction beam L0 may be reflected back into the light guide plate 200 by the reflecting mirror 400, which reduces energy loss.

In some embodiments, the phase retardation element 300B is a quarter-wave plate, and the light beam L is circularly polarized light. The light beam L penetrates through the phase retardation element 300B and is converted into an s-wave. Therefore, the major diffraction beam L1 generated after the light beam L is incident on the diffraction grating 100A is an s-wave. Since the phase retardation element 300B is disposed on the surface 201 of the light guide plate 200 and meanwhile extends to the transmission path of the major diffraction beam L1 before the major diffraction beam L1 is incident on the diffraction grating 100A, the major diffraction beam L1 forms into a p-wave after passing through the phase retardation element 300B twice. Therefore, the major diffraction beam L1 is a p-wave when leaving the phase retardation element 300B, which avoids the diffraction phenomenon of the major diffraction beam L1 due to being incident on the diffraction grating 100A. However, the invention is not limited thereto. In some embodiments, the circularly polarized light beam L is converted into a p-wave after penetrating through the phase retardation element 300B. Accordingly, the major diffraction beam L1 forms into an s-wave after passing through the phase retardation element 300B twice, thereby avoiding the diffraction phenomenon of the major diffraction beam L1 due to being incident on the diffraction grating 100A.

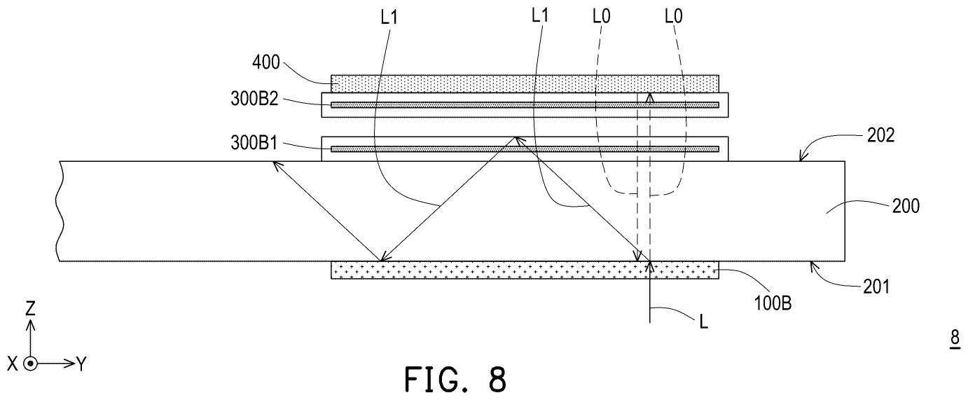

Referring to FIG. 8, FIG. 8 is a schematic diagram of a light guide device according to an eighth embodiment of the invention. A light guide device 8 includes the diffraction grating 100B, the light guide plate 200, a phase retardation element 300B1, a phase retardation element 300B2 and the reflecting mirror 400 stacked in sequence. The phase retardation element 300B1 and the phase retardation element 300B2 are located between the reflecting mirror 400 and the surface 202 of the light guide plate 200, and respectively include a protective layer (not indicated). In the embodiment, the phase retardation element 300B1 is disposed on the surface 202 of the light guide plate 200, and the phase retardation element 300B 1 is located between the surface 202 of the light guide plate 200 and the phase retardation element 300B2. In some embodiments, the phase retardation element 300B1 is attached to the surface 202 of the light guide plate 200, and the phase retardation element 300B2 is attached to the reflecting mirror 400.

The diffraction grating 100B serving as a coupling-in grating is disposed on the surface 201 of the light guide plate 200 and located outside the light guide plate 200, and the diffraction grating 100B is a transmissive diffraction grating. The light beam L penetrates through the diffraction grating 100B along an incident direction (+Z direction) and enters the light guide plate 200 through the surface 201 of the light guide plate 200. The major diffraction beam L1 generated after the light beam L is incident on the diffraction grating 100B is ±1^{st}-order diffraction light (or −1^{st}-order diffraction light), and a secondary diffraction beam L0 is generated, where the secondary diffraction beam L0 is 0^{th}-order diffraction light. As shown in FIG. 8, the major diffraction beam L1 exits the diffraction grating 100B at an angle relative to the incident direction, and therefore may be transmitted within the light guide plate 200. In addition, the secondary diffraction beam L0 may be reflected back into the light guide plate 200 by the reflecting mirror 400. The phase retardation element 300B1 and the phase retardation element 300B2 are both quarter wave plates.

In some embodiments, the light beam L is an s-wave. The major diffraction beam L1 generated after the light beam L is incident on the diffraction grating 100B is an s-wave. The major diffraction beam L1 first passes through the light guide plate 200 and the surface 202 thereof and then enters and passes through the phase retardation element 300B1, and gets totally reflected at the interface between the protective layer of the phase retardation element 300B1 and the air, and then again passes through the phase retardation element 300B1 and enters the light guide plate 200 through the surface 202 of the light guide plate 200 and is transmitted toward the diffraction grating 100A, so that the major diffraction beam L1 only passes through the phase retardation element 300B twice. The major diffraction beam L1 passes through the phase retardation element 300B1 twice and forms into a p-wave. Therefore, the major diffraction beam L1 is a p-wave when leaving the phase retardation element 300B1, which avoids the diffraction phenomenon of the major diffraction beam L1 due to being incident on the diffraction grating 100A.

In addition, the light beam L is an s-wave, and the secondary diffraction beam L0 generated after the light beam L is incident on the diffraction grating 100B is an s-wave. The secondary diffraction beam L0 from the diffraction grating 100B may be converted into a p-wave after continuously passing through the phase retardation element 300B1 and the phase retardation element 300B2. Then, the secondary diffraction beam L0 reflected by the reflecting mirror 400 and transmitted towards the light guide plate 200 again passes through the phase retardation element 300B1 and the phase retardation element 300B2, and the secondary diffraction beam L0 that returns to the light guide plate 200 is converted into an s-wave again. The secondary diffraction beam L0 is incident on the diffraction grating 100B and produces a diffraction phenomenon, and generates diffraction light that may be transmitted within the light guide plate 200. Since the secondary diffraction beam L0 is an s-wave before being incident on the diffraction grating 100B, it may have good diffraction efficiency. However, the invention is not limited thereto, as described in the above embodiments, the light beam L may also be a p-wave or non-polarized light without a polarization state, which may also avoid the diffraction phenomenon of the major diffraction beam L1 due to being incident on the diffraction grating 100B, and the secondary diffraction beam L0 may have good diffraction efficiency, which will not be repeated here.

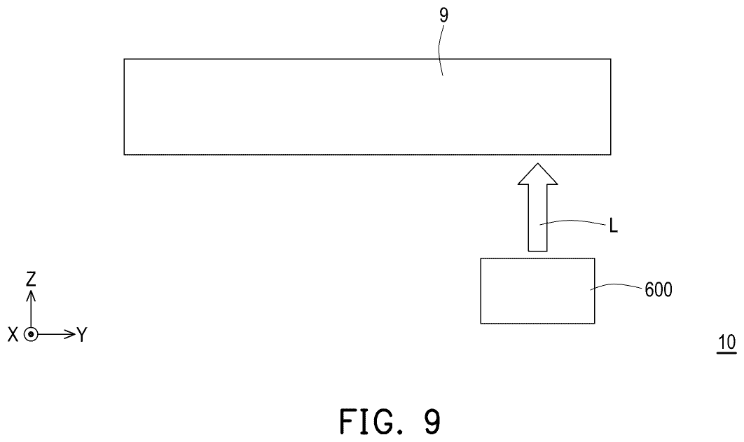

Referring to FIG. 9, FIG. 9 is a schematic diagram of a near-eye display according to the invention. A near-eye display 10 includes an image light source 600 and a light guide device 9. The image light source 600 is adapted to emit the light beam L. The light guide device 9 is disposed on the transmission path of the light beam L and is suitable for guiding the light beam L. The light guide device 9 may be replaced by any one of the light guide devices 1-8 in the embodiments shown in FIG. 1 to FIG. 8.

In summary, the light guide device and the near-eye display provided by the embodiments of the invention have at least one of the following features and advantages: (1) by controlling the polarization state of the diffraction beam, the diffraction beam is prevented from being diffracted again and losing energy due to re-incidence on the coupling-in grating; (2) by using a reflecting mirror to reflect the light emitted from the light guide plate back to the light guide plate, the intensity of the light transmitted in the light guide plate is enhanced, and energy loss is reduced; (3) recycling the 0^{th}-order secondary diffraction beam to enhance the intensity of the light transmitted in the light guide plate.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide device, adapted to guide a light beam, comprising:
a light guide plate;
a diffraction grating, disposed on a first surface of the light guide plate, wherein when the light beam is incident on the diffraction grating, the diffraction grating is adapted to generate a plurality of diffraction beams, the plurality of diffraction beams comprise a major diffraction beam, and the major diffraction beam is transmitted in the light guide plate; and
a phase retardation element, disposed on a transmission path of the major diffraction beam, wherein the major diffraction beam has a first polarization state before being incident on the phase retardation element, and the major diffraction beam has a second polarization state when leaving the phase retardation element, wherein the first polarization state is different from the second polarization state.

2. The light guide device as claimed in claim 1, wherein a part of the major diffraction beam passes through the phase retardation element once.

3. The light guide device as claimed in claim 1, wherein the first polarization state is perpendicular to the second polarization state.

4. The light guide device as claimed in claim 1, wherein the diffraction grating is a reflective diffraction grating.

5. The light guide device as claimed in claim 4, further comprising a first reflecting mirror disposed on the first surface of the light guide plate, wherein the diffraction grating is located between the first reflecting mirror and the light guide plate.

6. The light guide device as claimed in claim 5, further comprising a second reflecting mirror disposed on a second surface of the light guide plate, wherein the light guide plate is located between the first reflecting mirror and the second reflecting mirror.

7. The light guide device as claimed in claim 4, wherein the light beam penetrates through the phase retardation element before being incident on the diffraction grating.

8. The light guide device as claimed in claim 7, further comprising a first reflecting mirror disposed on the first surface of the light guide plate, wherein the diffraction grating is located between the first reflecting mirror and the light guide plate.

9. The light guide device as claimed in claim 7, wherein the light beam has a polarization state, and the phase retardation element is adapted to convert the polarization state into the first polarization state.

10. The light guide device as claimed in claim 1, wherein the diffraction grating is a transmissive diffraction grating.

11. The light guide device as claimed in claim 10, further comprising a first reflecting mirror disposed on a second surface of the light guide plate, wherein the first surface is opposite to the second surface.

12. The light guide device as claimed in claim 11, further comprising a second reflecting mirror disposed on the first surface of the light guide plate, wherein the diffraction grating is located between the second reflecting mirror and the light guide plate.

13. The light guide device as claimed in claim 10, wherein the plurality of diffraction beams further comprise a secondary diffraction beam, and the phase retardation element is disposed on a transmission path of the secondary diffraction beam.

14. The light guide device as claimed in claim 13, further comprising a first reflecting mirror, wherein the phase retardation element is located between the first reflecting mirror and the light guide plate.

15. The light guide device as claimed in claim 10, wherein the phase retardation element comprises a first phase retardation layer and a second phase retardation layer stacked to each other.

16. The light guide device as claimed in claim 15, further comprising a first reflecting mirror disposed on the first surface of the light guide plate, wherein the first phase retardation layer and the second phase retardation layer are located between the first surface of the light guide plate and the first reflecting mirror.

17. The light guide device as claimed in claim 16, wherein the first phase retardation layer is located between the first surface of the light guide plate and the second phase retardation layer.

18. The light guide device as claimed in claim 17, wherein the first phase retardation layer is disposed on the first surface of the light guide plate.

19. The light guide device as claimed in claim 17, wherein the second phase retardation layer is disposed on the first reflecting mirror.

20. The light guide device as claimed in claim 1, wherein the phase retardation element is parallel to the first surface of the light guide plate.

21. The light guide device as claimed in claim 1, wherein the phase retardation element is not parallel to the first surface of the light guide plate.

22. A near-eye display, comprising:
an image light source, adapted to emit a light beam; and
a light guide device, disposed on a transmission path of the light beam, adapted to guide the light beam, and the light guide device comprising:
a light guide plate;
a diffraction grating, disposed on a first surface of the light guide plate, wherein when the light beam is incident on the diffraction grating, the diffraction grating is adapted to generate a plurality of diffraction beams, the plurality of diffraction beams comprise a major diffraction beam, and the major diffraction beam is transmitted in the light guide plate; and
a phase retardation element, disposed on a transmission path of the major diffraction beam, wherein the major diffraction beam has a first polarization state before being incident on the phase retardation element, and the major diffraction beam has a second polarization state when leaving the phase retardation element, wherein the first polarization state is different from the second polarization state.
